(19) United States
(12) Patent Application Publication
(10) Pub. No.: US 2023/0370840 A1
(43) Pub. Date: Nov. 16, 2023

(54) METHOD, UE, AND NETWORK ENTITY FOR HANDLING SYNCHRONIZATION OF SECURITY KEY IN WIRELESS NETWORK

(71) Applicant: Samsung Electronics Co., Ltd., Suwon-si Gyeonggi-do (KR)

(72) Inventors: Rajavelsamy RAJADURAI, Bangalore, Karnataka (IN); Varini GUPTA, Bangalore, Karnataka (IN); Lalith KUMAR, Bangalore, Karnataka (IN); Rohini RAJENDRAN, Bangalore, Karnataka (IN); Nivedya Parambath SASI, Bangalore, Karnataka (IN); Danish Ehsan HASHMI, Bangalore, Karnataka (IN)

(21) Appl. No.: 18/029,514

(22) PCT Filed: Sep. 30, 2021
(86) PCT No.: PCT/KR2021/013441

§ 371 Date: Mar. 30, 2023

(30) Foreign Application Priority Data
Sep. 30, 2020 (IN) 202041042652
Sep. 20, 2021 (IN) 2020 41042652

(51) Int. Cl. H04W 12/06; H04W 12/0433

(52) U.S. Cl. CPC H04W 12/06; H04W 12/0433

(57) ABSTRACT

Embodiments herein provide a method for handling synchronization of Home Network (HN) security key(s) in a wireless network. The proposed method includes receiving a Non-access stratum (NAS) authentication request message from a network entity (200A), where the UE (100A) holds a first Home network (HN) security key. Further, the method includes determining an authentication response message for the received NAS authentication request message and generating a second HN security key from a plurality of input parameters received in the NAS authentication request message and sending authentication response message to the network entity (200A). Further, the method includes storing the second HN security key in response to receiving a NAS security mode command message from the network entity (200A) or ignore the second HN security key in response to receiving a NAS reject message from the network entity (200A).

### TECHNICAL FIELD

The present disclosure relates to authentication and key management, and more specifically related to a method, a User Equipment (UE) and network entity for handling security keys in a wireless network.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

In general, authentication of a user(s) (subscriber) and network functions is a critical component of a secure and dependable wireless network. Without proper authentication mechanisms, rogue users may get access to sensitive user data and impersonate them to engage in illegal activities. Therefore, a primary authentication and key agreement procedure are required to enable mutual authentication between a User Equipment (UE) of the user(s) and the wireless network. The primary authentication and key agreement procedure provide keying material (e.g. K_{AUSF}, K_{SEAF}, K_{AMF}, etc.) that can be used between the UE and the wireless network in subsequent security procedures are defined in existing Technical Specification (TS) 33.501 and TS 24.501. The existing TS 33.501 and TS 24.501 specify two primary authentication techniques. For example, an Extensible authentication protocol (EAP) based primary authentication and key agreement procedure and a 5^{th} Generation (5G) Authentication and Key Agreement (AKA) based primary authentication and key agreement procedure. But the existing TS 33.501 and TS 24.501 do not specify synchronization of the keying material between the UE and the wireless network, when a 5^{th} Generation (5G) Authentication and Key Agreement (AKA) based primary authentication and key agreement procedure is performed, the detailed example scenarios are explained in FIG. 4 to FIG. 6.

### DISCLOSURE OF INVENTION

### Technical Problem

The present disclosure provides a useful alternative for handling security key/keying material in the wireless network.

The principal object of the embodiments herein is to provide authentication and key management for handling latest security key (e.g. K_{AUSF-2}), between a UE and a wireless network, upon registration to 3^{rd} Generation Partnership Project (3GPP) and/or non-3gpp networks. Further, the method includes handling the latest security key after re-authentication via a new/old Authentication Server Function (AUSF). Further, the method includes handling the latest security key during registration via multiple Serving Networks (SNs). The handling of the latest security key between the UE and the wireless network provides improved synchronization between the UE and the wireless network. As a result, out-of-service of the UE is prevented, particularly the procedures and services which uses the home network key (K_{AUSF}).

Another object of the embodiment herein is to handle the latest security key (e.g. K_{AUSF-2}) based on reception of a message (e.g. a NAS SMC, Authentication Reject, etc.) from the wireless network by performing one of overwriting old security key (e.g. K_{AUSF-1}) with the latest security key and not overwriting the old security key with the latest security key.

### Solution to Problem

Accordingly, embodiments herein disclose a method for handling synchronization of Home Network (HN) security key(s) when re-authenticating a User Equipment (UE) using 5G Authentication and Key Agreement (AKA) based primary authentication and key agreement procedure in a wireless network. Further, the method includes receiving, by a User Equipment (UE), a Non-access stratum (NAS) authentication request message from a network entity (e.g. AMF,SEAF, etc.), wherein the UE holds a first HN security key (e.g. K_{AUSF-1}) Further, the method includes determining by the UE, an authentication response message for the received NAS authentication request message and generating a second HN security key (e.g. K_{AUSF-2}) from a plurality of input parameters (e.g. integrity keys (IK, CK)) received in the NAS authentication request message. Further, the method includes sending by the UE, the authentication response message to the network entity. Further, the method includes performing, by the UE, one of: storing the second HN security key in response to receiving a NAS security mode command message from the network entity or ignore the second HN security key in response to receiving a NAS reject message from the network entity.

In an embodiment, the UE holds the second HN security key and stores the second HN security key only after receiving the NAS security mode command message. The first HN security key is overwritten by the second HN security key.

In an embodiment, the network entity sends the NAS authentication request message to the UE for re-authenticating the UE.

In an embodiment, the first HN security key and the second HN security key are key K_{AUSF}, established between the UE (100A) and the HN resulting from the primary (re)authentication procedure.

In an embodiment, the NAS reject message comprises at least one of a service reject message, a registration reject message, and an authentication reject message.

In an embodiment, the method further includes determining, by the network entity, authenticity of the UE from a serving network point of view when the network entity receives a NAS authentication response message from the UE. Further, the method includes determining, by the network entity, authenticity of the UE (100A) from a home network point of view when the network entity receives a Nausf_UEAuthentication_Authenticate Response from an Authentication Server Function (AUSF) entity. Further, the method includes sending, by the network entity, a NAS Security Mode Command (SMC) message to the UE, if the network entity determines that the authenticity of the UE is verified successfully from both serving network point of view and home network point of view.

In an embodiment, the method includes determining when a new partial native 5G NAS security context is created and/or the newly created partial native 5G NAS security context is taken into use through a security mode control procedure. Further, the method includes performing, by the UE, one of: overwriting the first HN security key with the second HN security key in response to determining that the new partial native 5G NAS security context is created and/or the newly created partial native 5G NAS security context is taken into use through the security mode control procedure or not overwriting the first HN security key with the second HN security key in response to determining that the new partial native 5G NAS security context is not created and/or the newly created partial native 5G NAS security context is not taken into use through the security mode control procedure.

In an embodiment, the method includes initiating, by the UE, a registration procedure with 5GS registration type IE set to an emergency registration. Further, the method includes determining, by the UE, whether NAS Security mode procedure signals use of NIA0 and NEA0. Further, the method includes ignoring, by the UE, the second HN security key in response to determining that the NAS SMC procedure signals use of NIA0 and NEA0.

Accordingly, embodiments herein disclose the UE for handling synchronization of the HN security key(s) when re-authenticating the UE using the 5G AKA based primary authentication and the key agreement procedure in the wireless network. The UE includes a security key controller coupled with a processor and a memory. The security key controller is configured to receive the NAS authentication request message from the network entity, where the UE holds the first HN security key. Further, the security key controller is configured to determine the authentication response message for the received NAS authentication request message and generating the second HN security key from the plurality of input parameters received in the NAS authentication request message. Further, the security key controller is configured to send the authentication response message to the network entity. Further, the security key controller is configured to perform one of: storing the second HN security key in response to receiving the NAS security mode command message from the network entity. Further, the security key controller is configured to ignore the second HN security key in response to receiving the NAS reject message from the network entity.

Accordingly, embodiments herein disclose the network entity for handling synchronization of the HN security key(s) when re-authenticating the UE using the 5G AKA based primary authentication and the key agreement procedure in the wireless network. The network entity includes a security key controller coupled with a processor and a memory. The security key controller is configured to determine authenticity of the UE from a serving network point of view when the network entity receives a NAS authentication response message from the UE. Further, the security key controller is configured to determine authenticity of the UE from a home network point of view when the network entity receives a Nausf_UEAuthentication_Authenticate Response from a Authentication Server Function (AUSF) entity. Further, the security key controller is configured to send), a NAS Security Mode Command (SMC) message to the UE, if the network entity (200A) determines that the authenticity of the UE is verified successfully from both serving network point of view and home network point of view.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### Advantageous Effects of Invention

Embodiments of the present disclosure provide useful alternatives for handling security key/keying material in the wireless network.

### BRIEF DESCRIPTION OF DRAWINGS

This disclosure is illustrated in the accompanying drawings, throughout which like reference letters indicate corresponding parts in the various figures. The embodiments herein will be better understood from the following description with reference to the drawings, in which:

FIG. 1 is a sequence diagram illustrating various operations for initiating an authentication procedure and selecting an authentication method as described in TS 33.501, according to the prior art;

FIG. 2 is a sequence diagram illustrating various operations for a 5G AKA (TS 33.501) authentication procedure, according to the prior art;

FIG. 3 illustrates a key hierarchy generation in 5G system as described in the TS 33.501, according to the prior art;

FIG. 4A is a sequence diagram illustrating a scenario for handling a security key(s) (e.g. K_{AUSF}) during a successful authentication in a wireless network, according to the prior art;

FIG. 4B is a sequence diagram illustrating a scenario for handling a security key(s) (e.g. K_{AUSF}) during a successful authentication in a wireless network, according to the prior art;

FIG. 4C is a sequence diagram illustrating a scenario for handling a security key(s) (e.g. K_{AUSF}) during a successful authentication in a wireless network, according to the prior art;

FIG. 5A is a sequence diagram illustrating a problem scenario for handling the security key(s) during an unsuccessful authentication in the wireless network, according to the prior art;

FIG. 5B is a sequence diagram illustrating a problem scenario for handling the security key(s) during an unsuccessful authentication in the wireless network, according to the prior art;

FIG. 5C is a sequence diagram illustrating a problem scenario for handling the security key(s) during an unsuccessful authentication in the wireless network, according to the prior art;

FIG. 6 is a sequence diagram illustrating another problem scenario for handling the security key(s) during multiple registrations for different access networks, according to the prior art;

FIG. 7A is a sequence diagram illustrating a proposed method for handling the security key(s) in the wireless network, according to the embodiments as disclosed herein;

FIG. 7B is a sequence diagram illustrating a proposed method for handling the security key(s) in the wireless network, according to the embodiments as disclosed herein;

FIG. 7C is a sequence diagram illustrating a proposed method for handling the security key(s) in the wireless network, according to the embodiments as disclosed herein;

FIG. 7D is a sequence diagram illustrating a proposed method for handling the security key(s) in the wireless network, according to the embodiments as disclosed herein;

FIG. 8 is a signaling diagram illustrating a scenario for handling the security key(s) based on a timer and reception of a message(s) from the wireless network, according to the embodiments as disclosed herein;

FIG. 9 illustrates a signaling diagram as a combined embodiments as disclosed herein;

FIG. 10 illustrates a block diagram of a UE for handling the security key(s) in the wireless network, according to the embodiments as disclosed herein; and

FIG. 11 illustrates a block diagram of a network entity for handling the security key(s) in the wireless network, according to the embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components, or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

The term “AMF” and “SEAF” are used interchangeably throughout the document, which means AMF and/or SEAF and the message is from the AMF and/or the SEAF function. Throughout this disclosure, the terms “K_{AUSF #2}” and “K_{AUSF-2}” are used interchangeably and means the same. The terms “K_{AUSF #1}” and “K_{AUSF-1}” in are used interchangeably and means the same. Throughout this disclosure, the terms “AMF entity” and “AMF” are used interchangeably and means the same. Throughout this disclosure, the terms “AUSF entity” and “AUSF” are used interchangeably and means the same. Throughout this disclosure, the terms “UDM entity” and “UDM” are used interchangeably and means the same.

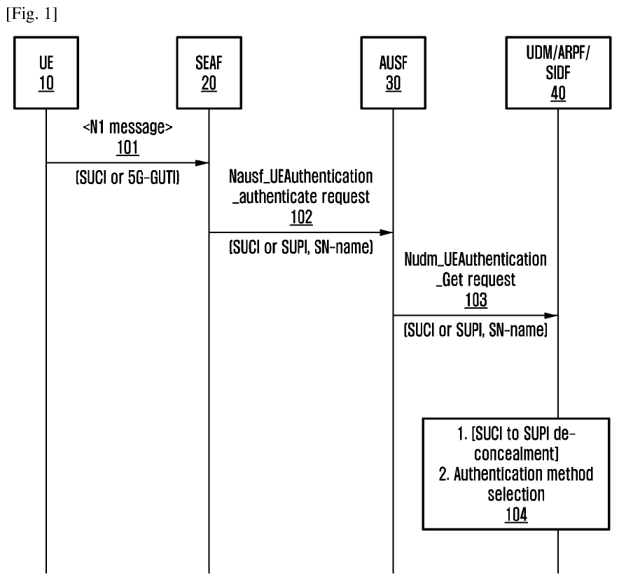

FIG. 1 is a sequence diagram illustrating various operations for initiating an authentication procedure and selecting an authentication method as described in TS 33.501, according to the prior art.

According to 3GPP-standards based on 5G networks, a home network (Unified Data Management (UDM) (40)) is responsible for ensuring that a user of a User Equipment (10) is authenticated in a serving-network (e.g. Security Anchor Function (SEAF) (20)) before the serving-network (20) can access the user's identity and subscription information, and when the user can access services offered by the serving-network (20).

At step 101, the UE (10) sends a Non-access stratum (NAS) message (e.g. N1 message) to the SEAF (20), where the NAS message includes a Subscription Concealed Identifier (SUCI) or 5G-Globally Unique Temporary ID (GUTI). At step 102, the SEAF (20) discovers and selects an Authentication Server Function (AUSF) (30) instance and requests the AUSF (30) to start the authentication procedure by sending a Nausf_UEAuthentication_Authenticate Request. Which includes the SUCI or a Subscription Permanent Identifier (SUPI) and a serving network name in case the SEAF (20) has a valid 5G-GUTI and re-authenticates the UE (10)

At step 103, the AUSF (30) downloads information required to authenticate the user from the UDM (40) and the AUSF (30) performs an authentication procedure as defined in 3GPP TS 33.501 and TS 24.501 by sending a Nudm_UEAuthentication_Get Request to the UDM (40). Which includes the SUCI or the SUPI and the serving network name. At step 104, based on the SUPI, the UDM (40) (or Authentication Credential Repository and Processing Function (ARPF) or Subscription Identifier De-concealing function (SIDF)) selects the authentication method (e.g. 5G AKA, EAP).

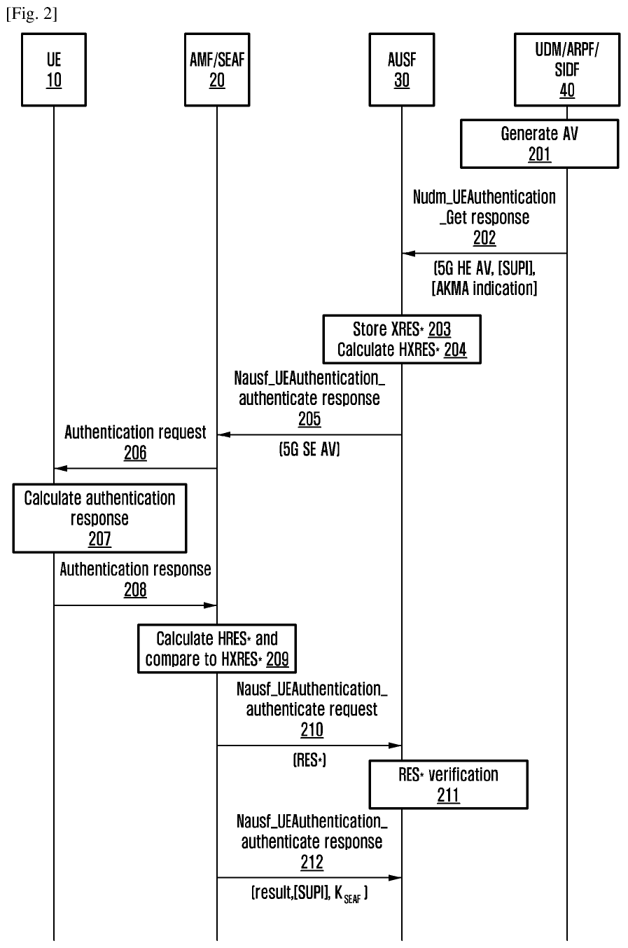

FIG. 2 is a sequence diagram illustrating various operations for a 5G AKA (TS 33.501) authentication procedure, according to the prior art.

At step 201, the UDM (40) generates a Fifth-Generation Home Environment Authentication Vector (5G-HEAV) for each authentication get request (Nudm_Authenticate_Get Request). The UDM (40) generates Authentication Vector (AV) with an Authentication Management Field (AMF) separation bit set to “1”. The UDM (40) then derives a K_{AUSF} and calculates an expected result (XRES*). The UDM (40) then generates the 5G-HEAV from a Random number (RAND), an Authentication Key (AUTN), the XRES*, and the K_{AUSF}.

At step 202, the UDM (40) sends the 5G-HEAV to the AUSF (30) with an indication that the 5G-HEAV is to be used for the 5G-AKA in a Nudm_UEAuthentication_Get Response. In case, the SUCI was included in the Nudm_UEAuthentication_Get Request, the UDM (40) includes the SUPI in the Nudm_UEAuthentication_Get Response. If the UE (10) has an AKMA subscription, then the UDM (40) includes an AKMA indication in the Nudm_UEAuthentication_Get Response.

At step 203, the AUSF (30) temporarily stores the XRES* with the received SUCI or SUPI. At step 204, the AUSF (30) then generates a 5G-AV from the 5G-HEAV received from the UDM (40) by determines an HXRES* from the XRES* and a K_{SEAF} from the K_{AUSF} and the AUSF (30) replaces the XRES* with the HXRES* and the K AUSF with the K_{SEAF} in the 5G-HEAV. At step 205, the AUSF (30) then removes the K s sends a 5G-SEAV (i.e. RAND, AUTN, HXRES*) to the SEAF (20) in a Nausf_UEAuthentication_Authenticate Response.

At step 206, the SEAF (20) (or AMF) sends the RAND, the AUTN to the UE (10) in a NAS authentication request message. The NAS authentication request message includes a key set identifier (ngKSI) which is used by the UE (10) and the AMF (20) to identify a K_{AMF} and a partial native security context that is created if authentication is successful. The UE (10) forwards the RAND and AUTN received in NAS authentication request message to a UMTS Subscriber Identity Module (USIM) of the UE (10).

At step 207, the USIM of the UE (10) verifies the freshness of the 5G-AV by checking whether the AUTN can be accepted on receiving the RAND and the AUTN from the AMF (20). If the AUTN is accepted, then the USIM of the UE (10) computes a response (RES). Then the USIM of the UE (10) returns the RES, a plurality of integrity keys (IK, CK) to the UE (10). The UE (10) then determines a RES* from the RES. The UE (10) calculates a new K_{AUSF} (e.g. K_{AUSF #2}) from the CK∥IK. The UE (10) then calculates a K_{SEAF} from the K_{AUSF}. The UE (10) accessing 5G checks during authentication that a “separation bit” in the AMF field of the AUTN is set to 1. The “separation bit” is bit 0 of the AMF field of the AUTN. The UE (10) overwrites the K AUSF (e.g. old key: K_{AUSF #1}) on a calculation of the new K_{AUSF} (e.g. K_{AUSF #2}), which is one of the major drawbacks of the existing method (TS 33.501) where the existing method updates/modifies/overwrites the old key without concern of other network entities (i.e. AMF (20), AUSF (30)).

At step 208, the UE (10) sends the RES* to the SEAF (20) in a NAS authentication response message. At step 209, the SEAF (20) determines a Hash RESponse (HRES*) from the RES*. The SEAF (20) then compares the HRES* with the Hash eXpected RESponse HXRES*. If the HRES* with the HXRES* are coincide with each other, then the SEAF (20) considers that the authentication is successful from a serving network point of view. If the UE (10) is not reached/the RES* is never received by the SEAF (20), then the SEAF (20) considers that the authentication is failed, and indicates a failure to the AUSF (30).

At step 210, the SEAF (20) sends the RES*, which is received from the UE (10) in a Nausf_UEAuthentication_Authenticate Request message to the AUSF (30). At step 211, the AUSF (30) determines whether the Av is expired on receiving the Nausf_UEAuthentication_Authenticate Request message from the SEAF (20). If the AV is expired, then the AUSF (30) considers that the authentication is failed from a home network point of view. If the AV is not expired, then the AUSF (30) stores the K_{AUSF}. The AUSF (30) compares the received RES* with the stored XRES*. If the RES* and XRES* are equal, the AUSF (30) considers that the authentication is successful from the home network point of view. At step 212, the AUSF (30) indicates to the SEAF (20) in a Nausf_UEAuthentication_Authenticate Response whether the authentication was successful or not from the home network point of view. If the authentication was successful, then the K_{SEAF} is sent to the SEAF (20) in the Nausf_UEAuthentication_Authenticate Response.

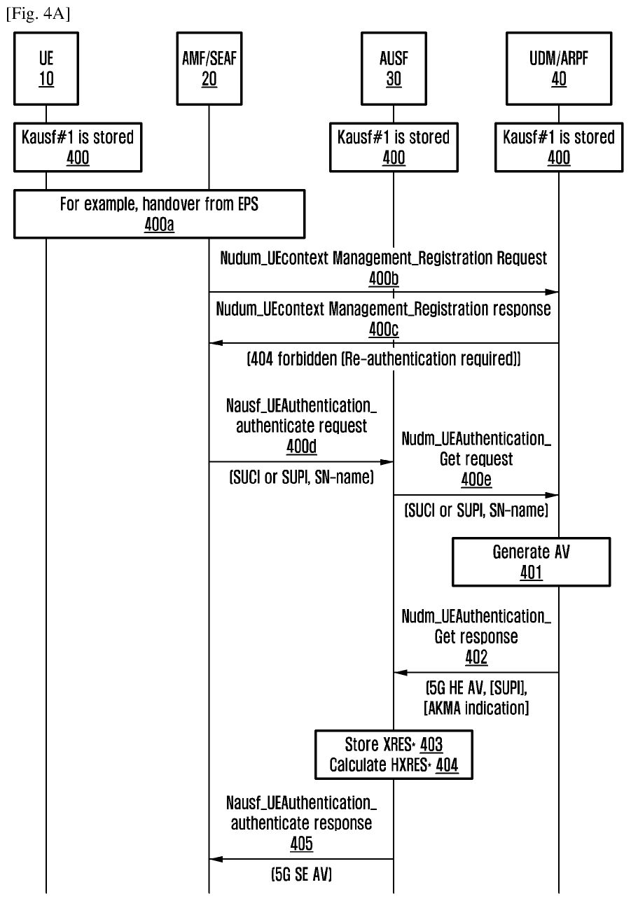

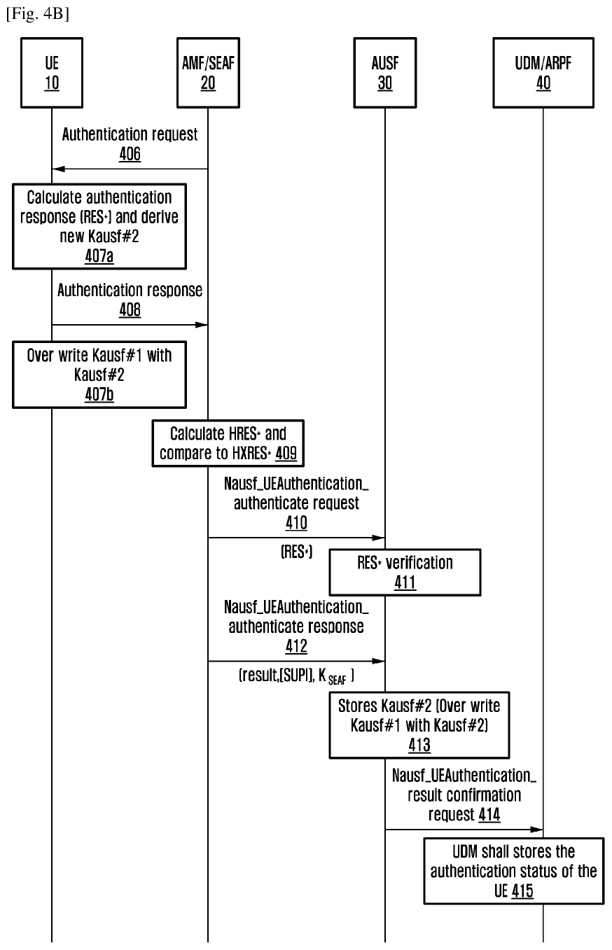

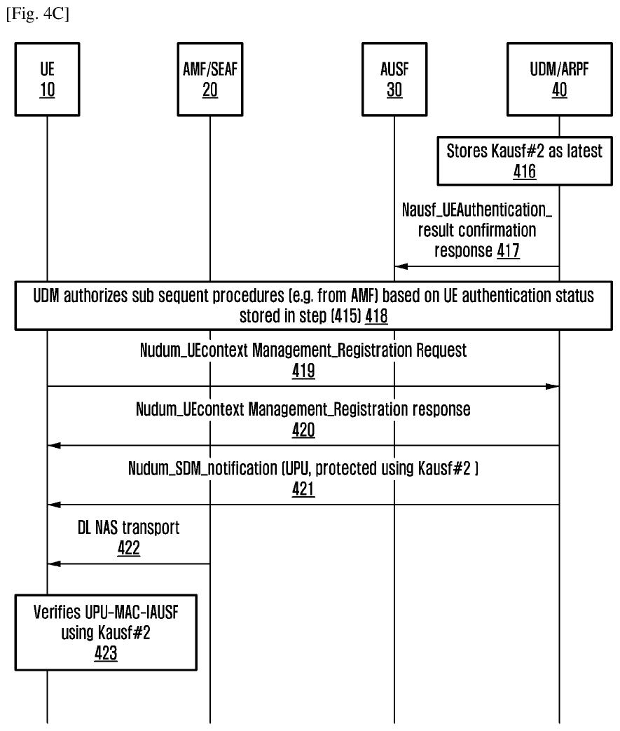

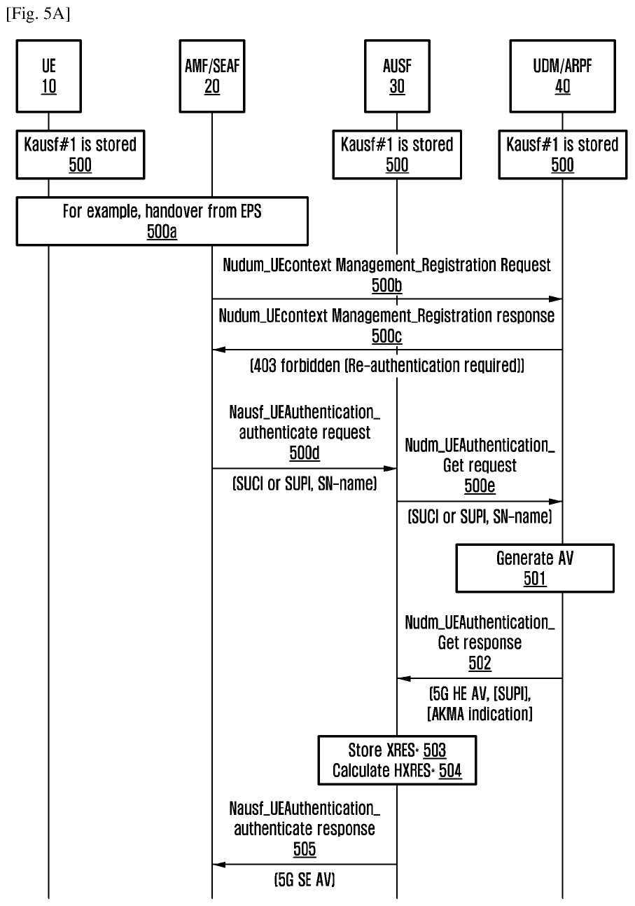

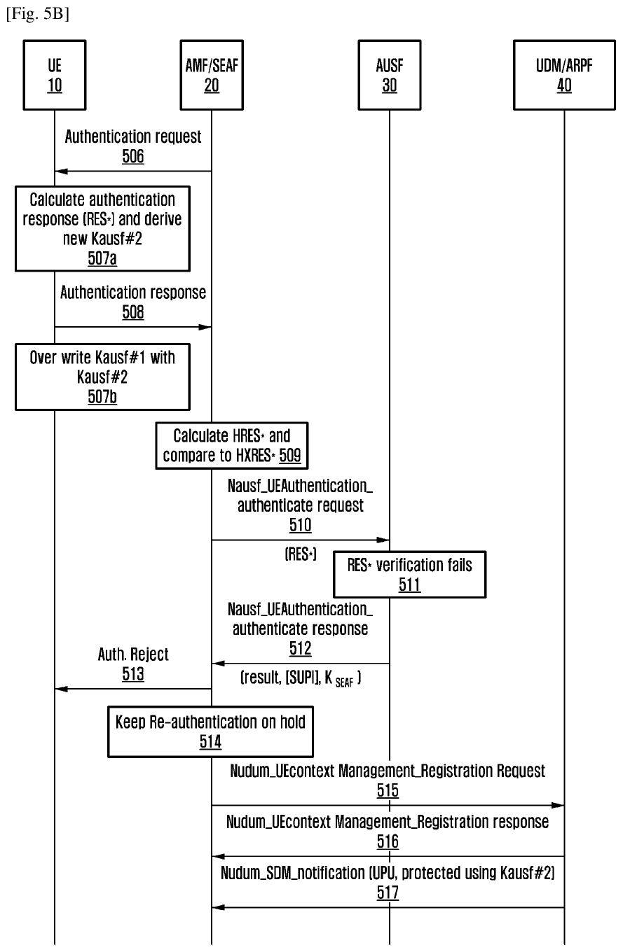

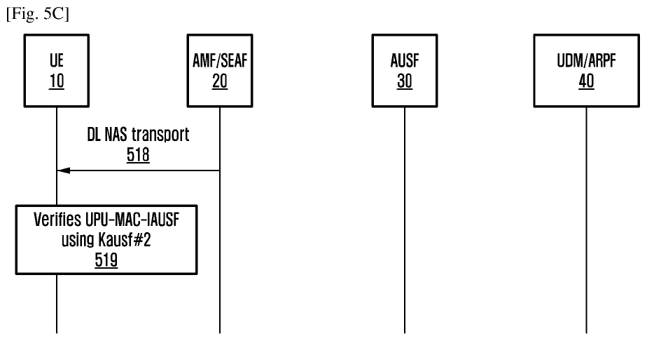

So, in the 5G AKA-based primary authentication and key agreement procedure, particularly, there is no indication from the network (20/30/40) to the UE (10) indicating (explicitly or implicitly) whether the primary authentication is successfully completed or not. There is an issue in taking the newly derived key K_{AUSF} as the latest key and being in sync between the UE (10) and the home network, with the usage of the latest K_{AUSF} Due to no indication of the network (20/30/40) on the status of the primary authentication, the UE (10) may not be in sync with the network (20/30/40) in considering the newly derived key K_{AUSF} as the latest key, further details are explained in FIG. 4 and FIG. 5.

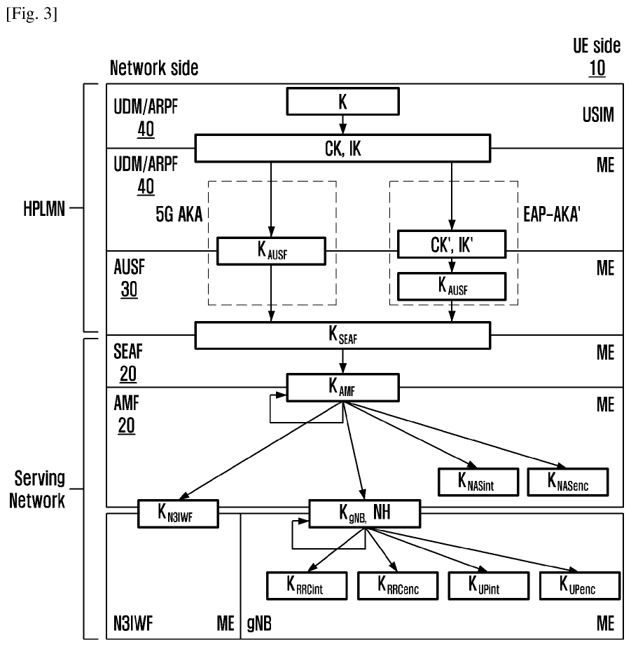

FIG. 3 illustrates a key hierarchy generation in the 5G system as described in the TS 33.501, according to the prior art.

In case EAP-AKA′ is used as authentication method, the AUSF shall derive a key K_{AUSF} from CK′ and IK′ for EAP-AKA′ as specified in clause 6.1.3.1. In case that 5G AKA is used as authentication method, the UDM/ARPF shall generate the K_{AUSF} as specified in clause 6.1.3.2.

The K_{AUSF} may be stored in the AUSF between two subsequent authentication and key agreement procedures. When the AUSF stores the K_{AUSF}, the AUSF shall store the latest K_{AUSF} generated after successful completion of the latest primary authentication. The authentication is considered as successful and the AUSF shall store the latest K_{AUSF} or replace the old K_{AUSF} with the new K_{AUSF} (if the AMF(s) end up selecting the same AUSF instance for (re)authentication of the UE):

In case 5G AKA is used as authentication method, when the RES* and the XRES* are equal (see clause 6.1.3.2.0, Step 11).

In case EAP-AKA′ is used as authentication method, when the AUSF sends an EAP-Success message to the SEAF (see clause 6.1.3.1, Step 10).

The AUSF shall generate the anchor key, also called K_{SEAF}, from the authentication key material received from the ARPF during an authentication and key agreement procedure.

Once authentication is successful, the UDM (40) stores an AUSF instance ID that authenticated the UE (10), while the selected AUSF instance stores key (K_{AUSF}) is generated as part of the authentication procedure. Which helps the UDM (40) to send any future protected message to the UE (10) (e.g. Steering-of-Roaming (SoR) Information or other UE configuration parameters). The UE (10) also generates and stores the K_{AUSF} which can verify the integrity of the message and/or decrypt the messages sent by the home network via the serving network.

When the home network needs to authenticate the UE (10) again after initial authentication, due to the UE (10) registering simultaneously in another serving network via non-3GPP access, or other factors. The AMF (20) may select a new AUSF instance, and a new K_{AUSF} may be generated in the UE (10) as well as a new AUSF instance as a result of the successful authentication procedure. In such a scenario, it is expected that network (20/30/40)/UE (10) uses only the latest K_{AUSF} for protecting further communication. The K_{AUSF} is an additional key established between the UE (10) and home network resulting from a primary authentication procedure. The K_{AUSF} may be securely stored in the AUSF (30) based on the home operator's policy on using such key e.g. if a control plane solution for the SoR or UE Parameter update procedures is supported by a Home Public Land Mobile Network (HPLMN).

The UE (10) stores the latest K_{AUSF} after the successful completion of the latest primary authentication. If the USIM supports 5G parameters storage, then the K_{AUSF} is stored in the USIM. Otherwise, the K_{AUSF} is stored in the non-volatile memory of the ME/UE (10). The K_{AUSF} may be stored in the AUSF (30) between two subsequent authentication and key agreement procedures. When the AUSF (30) stores the K_{AUSF}, the AUSF (30) stores the latest K_{AUSF} generated after successful completion of the latest primary authentication.

Handling the K_{AUSF} in multiple registrations: There are two cases where the UE (10) can be multiple registered in different PLMN's serving networks or the same PLMN's serving networks.

The first case is when the UE (10) is registered in one PLMN serving network over a certain type of access (e.g. 3GPP) and is registered to another PLMN serving network over the other type of access (e.g. non-3GPP).

The second case is where the UE (10) is registered in the same AMF (20) in the same PLMN serving network over both 3GPP and non-3GPP accesses.

The UE (10) establishes two NAS connections with the network in both cases (i.e. a and b). However, only one K_{AUSF} (latest one) is maintained in the AUSF (30) and the UE (10), as the K_{AUSF} is a security association between the UE (10) and the HPLMN. The AUSF (30) in the home PLMN never maintains two K_{AUSF}, when the user of the UE (10) is simultaneously registered in two Serving Networks via different access types (3gpp and non-3gpp). The stored K_{AUSF} does not have any dependence on the serving network, even though K_{AUSF} derivation uses a serving network ID as an input (SN ID is included for backward compatibility with pre-Rel-15 UICC). Further, keys derived from the K_{AUSF} are serving network specific, but the K_{AUSF} is not specific to the serving network and it's the key associated between the UE (10) and the home network.

For the 5G security context, the 5G security context is between the UE (10) and the serving network and the K_{AUSF} is not part of the 5G security context. The UE (10) independently maintains and uses two different 5G security contexts (for example, a 5G NAS security context and a 5G AS security context (s)), one per PLMN's serving network, but the UE (10) and the HPLMN maintains only one K_{AUSF} based on the most recent successful authentication. There is no need for maintaining multiple K_{AUSF} in the UE (10) and the HPLMN. Further keeping old keys laying around in the network is not a good security practice.

The UDM (40) stores authentication events for both serving networks in the multiple registrations. The UDM (40) selects the AUSF (30) reporting the most recent successful authentication result. To prevent the SoR and UPU failure in the case where the UE (10) having multiple registrations de-registers from the new serving network.

The AUSF (30) and the UE (10) stores newest K_{AUSF} after UE deregistration;

The UDM (40) keeps the AUSF info in the authentication events when deleting authentication results for the new serving network.

When two different AUSFs are selected by two serving PLMNs, the UDM (40) selects the latest AUSF which served the UE (10) and maintains the latest K_{AUSF} for SoR protection or UPU protection services. The UDM (40) selects the latest AUSF, irrespective of the serving network to which the SoR protection or UPU protection services is to be provided. When the same AUSF (30) is selected by the two serving PLMNs, the AUSF (30) stores only the latest K_{AUSF} upon successful authentication procedure and deletes any stored old K_{AUSF}. The UE (10) stores only the latest K_{AUSF} upon successful authentication procedure and deletes any stored old K_{AUSF}, further details are explained in FIG. 4 and FIG. 5.

FIG. 4A to FIG. 4C are sequence diagrams illustrating scenario for handling a security key(s) (e.g. K_{AUSF}) during the successful authentication in a wireless network (i.e. network (20/30/40)), according to the prior art.

At steps 400-400a, a precondition of this illustrative message sequence is that the K_{AUSF} (i.e. KAUSF #1) is established between the UE (10) and the home network (the AUSF (30) and the UDM (40)) resulting from a primary (re)authentication procedure. The UE (10) is moving from an Evolved Packet System (EPS) to a 5G system (5GS), due to handover, so as part of the handover procedure, the AMF (20) requests the UDM (40) for a UE context management registration.

At step 400b, the AMF/SEAF (20) sends a Nudm_UEContextManagement_Registration request message to the UDM/ARPF (40). At step 400c, the UDM (40) sends Nudm_UEContextManagement_Registration response message indication with 404 forbidden error (re-authentication procedure required), when the UDM (40) decides the need for (re)authentication. At step 400d, the AMF (20) sends a Nausf_UEAuthentication_Authenticate Request message to initiate the re-authentication procedure. The AMF (20) includes the SUPI and the serving network name in the Nausf_UEAuthentication_Authenticate Request message in case the SEAF has a valid 5G-GUTI and re-authenticates the UE (10). At step 400e, the AUSF (30) sends a Nudm_UEAuthentication_Get Request to the UDM (40). The Nudm_UEAuthentication_Get Request includes the SUCI or the SUPI and the serving network name. The AMF (20) may start illustrative sequence from step 400d, for performing periodic authentication procedures or to refresh/rekeying key hierarchy (from mapped security context to native security context), like so. Based on the SUPI, the UDM (40) selects the authentication method.

At step 401, the UDM (40) generates the 5G-HEAV for each authentication get request (Nudm_Authenticate_Get Request). The UDM (40) generates the AV with the AMF separation bit set to “1”. The UDM (40) then derives the K_{AUSF} and calculates the XRES*. The UDM (40) then generates the 5G-HEAV from the RAND, the AUTN, the XRES*, and the K_{AUSF}.

At step 402, the UDM (40) sends the 5G-HEAV to the AUSF (30) with an indication that the 5G-HEAV is to be used for the 5G-AKA in the Nudm_UEAuthentication_Get Response. In case, the SUCI was included in the Nudm_UEAuthentication_Get Request, the UDM (40) includes the SUPI in the Nudm_UEAuthentication_Get Response. If the UE (10) has the AKMA subscription, then the UDM (40) includes the AKMA indication in the Nudm_UEAuthentication_Get Response.

At step 403, the AUSF (30) temporarily stores the XRES* with the received SUCI or SUPI. At step 404, the AUSF (30) then generates the 5G-AV from the 5G-HEAV received from the UDM (40) by determines the HXRES* from the XRES* and the K_{SEAF} from the K_{AUSF} and the AUSF (30) replaces the XRES* with the HXRES* and the K_{AUSF} with the K_{SEAF} in the 5G-HEAV. At step 405, the AUSF (30) then removes the K s sends the 5G-SEAV (i.e. RAND, AUTN, HXRES*) to the SEAF (20) in the Nausf_UEAuthentication_Authenticate Response.

At step 406, the SEAF (20) (or AMF) sends the RAND, the AUTN to the UE (10) in the NAS authentication request message. The NAS authentication request message includes the ngKSI which is used by the UE (10) and the AMF (20) to identify the K AMF and the partial native security context that is created if the authentication is successful. The UE (10) forwards the RAND and AUTN received in NAS authentication request message to the USIM of the UE (10).

At step 407a, the USIM of the UE (10) verifies the freshness of the 5G-AV by checking whether the AUTN can be accepted on receiving the RAND and the AUTN from the AMF (20). If the AUTN is accepted, then the USIM of the UE (10) computes a response (RES). Then the USIM of the UE (10) returns the RES, the plurality of integrity keys (IK, CK) to the UE (10). The UE (10) then determines a RES* from the RES. The UE (10) calculates a new K_{AUSF} (e.g. K_{AUSF #2}) from the CK∥IK. The UE (10) then calculates a K_{SEAF} from the K_{AUSF}. The UE (10) accessing 5G checks during authentication that the “separation bit” in the AMF field of the AUTN is set to 1. The “separation bit” is bit 0 of the AMF field of the AUTN. At step 407b, The UE (10) overwrites the K_{AUSF} (e.g. old key: K_{AUSF #1}) on the calculation of the new K_{AUSF} (e.g. K_{AUSF #2}), which is one of the major drawbacks of the existing method (TS 33.501) where the existing method updates/modifies/overwrites the old key without concern of other network entities (i.e. AMF (20), AUSF (30)).

At step 408, the UE (10) sends the RES* to the SEAF (20) in the NAS authentication response message. At step 409, the SEAF (20) determines the HRES* from the RES*. The SEAF (20) then compares the HRES* with the HXRES*. If the HRES* with the HXRES* are coincide with each other, then the SEAF (20) considers that the authentication is successful from the serving network point of view. If the UE (10) is not reached/the RES* is never received by the SEAF (20), then the SEAF (20) considers that the authentication is failed, and indicates a failure to the AUSF (30).

At step 410, the SEAF (20) sends the RES*, which is received from the UE (10) in the Nausf_UEAuthentication_Authenticate Request message to the AUSF (30). At step 411, the AUSF (30) determines whether the Av is expired on receiving the Nausf_UEAuthentication_Authenticate Request message from the SEAF (20). If the AV is expired, then the AUSF (30) considers that the authentication is failed from the home network point of view. If the AV is not expired, then the AUSF (30) stores the K AUSF The AUSF (30) compares the received RES* with the stored XRES*. If the RES* and XRES* are equal, the AUSF (30) considers that the authentication is successful from the home network point of view. At step 412, the AUSF (30) indicates to the SEAF (20) in the Nausf_UEAuthentication_Authenticate Response whether the authentication was successful or not from the home network point of view. If the authentication was successful, then the K_{SEAF} is sent to the SEAF (20) in the Nausf_UEAuthentication_Authenticate Response.

At step 413, the AUSF (30) stores the new K_{AUSF} (K_{AUSF #2}) overwriting the old one K_{AUSF #1} when the authentication was successful. At step 414, the AUSF (30) sends a Nudm_UEAuthentication_ResultConfirmation Request to the UDM (40) to inform about the result and time of the authentication procedure with the UE (10). The Nudm_UEAuthentication_ResultConfirmation Request includes the SUPI, a timestamp of the authentication, an authentication type (e.g. EAP method or 5G-AKA), and the serving network name.

At step 415, the UDM (40) stores an authentication status of the UE (10) (e.g. the SUPI, the authentication result, the timestamp, and the serving network name). At step 416, the UDM (40) considers or records the details of the UE's authentication events on receiving the authentication status, which has details of the AUSF, which is in possession of the latest key K_{AUSF #2} (maybe using the timestamp). At step 417, the UDM (40) sends a Nudm_UEAuthentication_ResultConfirmation Response to the AUSF (30).

At step 418, the UDM (40) proceeds with subsequent procedures authorization based on the stored authentication status in step 415. At steps 419-420, the UE's (10) serving AMF (20) (or SEAF) registers itself on the UDM (40) by sending a Nudm_UEContextManagement_Registration request message. The UDM (40) responds with a Nudm_UEContextManagement_Registration response message indicating 204 no content status (means, registration is successful).

At step 421, the UDM (40) notifies the AMF (20) of updates of subscription data indicated by a “subscription data type” input additional UDM-related parameters and UPU-MAC-I_{AUSF} protected using the K_{AUSF #2} (by the AUSF (30)) by sending a Nudm_SDM_Notification message. At step 422, the AMF (20) sends a DL NAS transport message to the served UE (10) upon receiving the Nudm_SDM_Notification message. The AMF (20) includes in the DL NAS transport message the transparent container received from the UDM (40). At step 423, the UE (10) calculates a UPU-MAC-I_{AUSF} using the K_{AUSF #2} and verifies whether it matches the UPU-MAC-I_{AUSF} value received in the DL NAS transport message. If successful, then the UE (20) proceeds with further procedure.

So, it is not clear, how the UE (10) and the home network (e.g. the UDM (40)) get in sync with the usage of the latest K_{AUSF}. Also, the existing procedure does not clearly indicate when the authentication procedure is to be considered as successful so that the newly generated K_{AUSF} will be considered as the latest. As there are possible scenarios, where the UE (10) considers authentication is not successful, for example, when a NAS SMC check fails at the UE (10), however, at the home network side the authentication is considered to be successful and updates the newly generated K_{AUSF} as the latest K_{AUSF}. Another possible scenario is that the UE (10) considers authentication is successful if the AUTN is successfully verified. Whereas in the network (20/30/40), the K_{AUSF} is not updated, as the network (20/30/40) is considered a failure in authentication and will not indicate the home network.

In case when the UE (10) disconnects from the network (20/30/40) and the AMF (20) decides to purge the UE (10), the AMF (20) sends a purge indication to the UDM (40). Which may prompt the UDM (40) to delete its association with the corresponding AUSF (30) by deleting its information from its database. Additionally, the AMF (20) may send an indication to the AUSF (30) instance to delete UE's security information (which includes, K_{AUSF}), so that it does not unnecessarily maintain unused (no-longer-used) keys in its database.

FIG. 5A to FIG. 5C are sequence diagrams illustrating a problem scenario for handling the security key(s) during an unsuccessful authentication in the wireless network, according to the prior art.

Steps 500 to 510 are the same as steps 400 to 410 as explained in FIG. 4. At step 511, the AUSF (30) determines whether the AV has expired or not. If the AV has expired, the AUSF (30) may consider the authentication as unsuccessful from the home network point of view. If the AV has not expired, the AUSF (30) may consider the authentication as successful from the home network point of view. The AUSF (30) stores the K_{AUSF} (i.e. same K_{AUSF #2}, the newly generated one at the UE (10)). The AUSF (30) then compares the received RES* with the stored XRES*. If the RES* and XRES* are unequal, the AUSF (30) considers the authentication as a failure.

At step 512, the AUSF (30) sends the Nausf_UEAuthentication_Authenticate Response to the SEAF (20), the Nausf_UEAuthentication_Authenticate Response indicates that the authentication is unsuccessful from the home network point of view. At step 513, the AMF (20) sends may or may not sends an authentication reject message to the UE (10). If the AMF (20) does not send the authentication reject message to the UE (10) and the AMF (20) holds a re-authentication process for a later point of time (one of the scenarios for such condition is for “emergency registration” and another scenario may be the AMF (20) was not able to successfully deliver the authentication reject message to the UE (10))

At steps 514-516, the SEAF re-send the context management registration request in the Nudm_UEContextManagement_Registration Request and the UDM (40) responds with the Nudm_UEContextManagement_Registration response message indicating 204 no content status. The UDM (40) might not, in particular, perform re-authentication for the UE (10). At step 517, the UDM (40) sends the Nudm_SDM_Notification message. Which includes the updated UDM data, or the SoR information along with the UPU MAC (Protected using K_{AUSF #1}) At step 518, the AMF (20) sends the DL NAS transport message to the served UE (10) upon receiving the Nudm_SDM_Notification message. The AMF (20) includes in the DL NAS Transport message the transparent container received from the UDM (40). At step 519, the UE (10) overwrites the K_{AUSF #1} with the K_{AUSF #2}, in result the UPU-MAC-I_{AUSF} using the K_{AUSF #2} and verifies that does not match the UPU-MAC-I_{AUSF} value received in the DL NAS transport message.

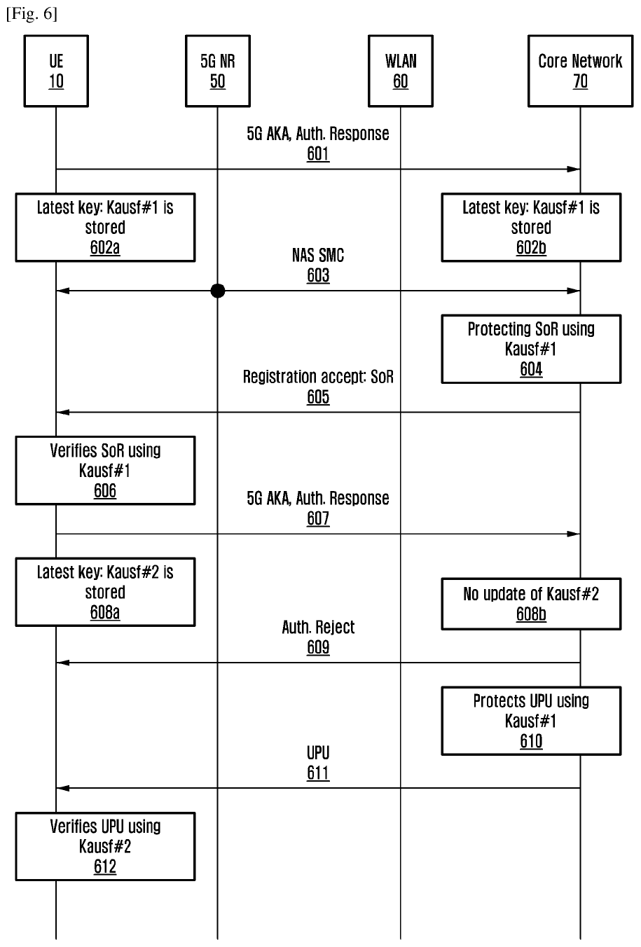

FIG. 6 is a sequence diagram illustrating another problem scenario for handling the security key(s) during multiple registrations for different access networks, according to the prior art.

At step 601, the UE (10) and a core network (70) performs the 5G AKA-based authentication procedure for first access. At steps 602a-602b, the UE and the core network stores the K_{AUSF-1} after the successful authentication. At step 603, the UE (10) and AMF (20) (not shown in FIG. 6) perform a NAS SMC procedure, and based on that NAS keys are generated. The NAS SMC is used to establish a NAS security context between the UE (10) and the AMF (20). This procedure consists of a roundtrip of messages between the AMF (20) and the UE (10) as indicated in the 6.7.2 clause of TS 33.501. The AMF (20) sends the NAS security mode command message to the UE (10) and the UE (10) replies with the NAS security mode complete message. At steps 604-605, at the network side, the SoR is protected using the K_{AUSF-1} and provides registration accepts with the SoR info to the UE (10).

At step 606, the UE (10) verifies the SoR using the K_{AUSF-1}, and the verification procedure is successfully completed. At step 607, the UE (10) is trying to access new PLMN using its credentials and performs an authentication procedure with the core network as performed in step 601 for a first PLMN. At step 608a, the UE (10) stores the latest K_{AUSF} i.e. K_{AUSF-2} based on the successful AUTN verification results. At step 608b, the UE (10) considers the authentication is successful, if the AUTN is successfully verified. Whereas in the core network (70), the K_{AUSF} is not updated, as the network is considered as fail in authentication and will not indicate the home network.

At step 609, the core network (70) sends the authentication reject message to the UE (10) as there is no K_{AUSF} update at the core network (70). At steps 610-611, the core network (70) (e.g. UDM) is not having the updated key. Therefore, the UDM (40) protects the UPU MAC with the old K_{AUSF} i.e. K_{AUSF-1}. The UDM (40) sends the protected MAC to the UE (10) for further verification. At step 612, the UE (10) verifies the received UPU MAC with the updated K_{AUSF-2}. This leads to a miss-match in keys stored and received and further leads to authentication failure scenario. Thus, it is desired to implement a proposed method, which demands a need to specify how the UE and network handle the latest security key (K_{AUSF}).

Accordingly, embodiments herein disclose a method for handling synchronization of Home Network (HN) security key(s) when re-authenticating a User Equipment (UE) using 5G Authentication and Key Agreement (AKA) based primary authentication and key agreement procedure in a wireless network. Further, the method includes receiving, by a User Equipment (UE), a Non-access stratum (NAS) authentication request message from a network entity (e.g. AMF,SEAF, etc.), wherein the UE holds a first HN security key (e.g. K_{AUSF-1}). Further, the method includes determining by the UE, an authentication response message for the received NAS authentication request message and generating a second HN security key (e.g. K_{AUSF-2}) from a plurality of input parameters (e.g. integrity keys (IK, CK)) received in the NAS authentication request message. Further, the method includes sending by the UE, the authentication response message to the network entity. Further, the method includes performing, by the UE, one of: storing the second HN security key in response to receiving a NAS security mode command message from the network entity or ignore the second HN security key in response to receiving a NAS reject message from the network entity.

Accordingly, embodiments herein disclose the UE for handling synchronization of the HN security key(s) when re-authenticating the UE using the 5G AKA based primary authentication and the key agreement procedure in the wireless network. The UE includes a security key controller coupled with a processor and a memory. The security key controller is configured to receive the NAS authentication request message from the network entity, where the UE holds the first HN security key. Further, the security key controller is configured to determine the authentication response message for the received NAS authentication request message and generating the second HN security key from the plurality of input parameters received in the NAS authentication request message. Further, the security key controller is configured to send the authentication response message to the network entity. Further, the security key controller is configured to perform one of: storing the second HN security key in response to receiving the NAS security mode command message from the network entity. Further, the security key controller is configured to ignore the second HN security key in response to receiving the NAS reject message from the network entity.

Accordingly, embodiments herein disclose the network entity for handling synchronization of the HN security key(s) when re-authenticating the UE using the 5G AKA based primary authentication and the key agreement procedure in the wireless network. The network entity includes a security key controller coupled with a processor and a memory. The security key controller is configured to determine authenticity of the UE from a serving network point of view when the network entity receives a NAS authentication response message from the UE. Further, the security key controller is configured to determine authenticity of the UE from a home network point of view when the network entity receives a Nausf_UEAuthentication_Authenticate Response from a Authentication Server Function (AUSF) entity. Further, the security key controller is configured to send), a NAS Security Mode Command (SMC) message to the UE, if the network entity (200A) determines that the authenticity of the UE is verified successfully from both serving network point of view and home network point of view.

Unlike existing methods and systems, the proposed method allows the UE and the network entities (e.g. AMF/UDM/AUSF) to provide authentication and key management for handling a latest security key (e.g. K_{AUSF-2}), between the UE and the wireless network, upon simultaneous registration to 3GPP and non-3gpp networks and/or handling the latest security key after re-authentication via a new AUSF and/or handling the latest security key during registration via multiple SNs. The handling of the latest security key between the UE and the wireless network provides improves synchronization between the UE and the wireless network. As a result, the UE and wireless network reduce signaling and preserve network resources.

Unlike existing methods and systems, the proposed method allows the UE and the network entities to handle the latest security key (e.g. K_{AUSF-2}) based on reception of a message (e.g. a NAS SMC, a registration accept message, a registration reject message, etc.) from the wireless network by performing one of overwriting old security key (e.g. K_{AUSF-1}) with the latest security key and not overwriting the old security key with the latest security key.

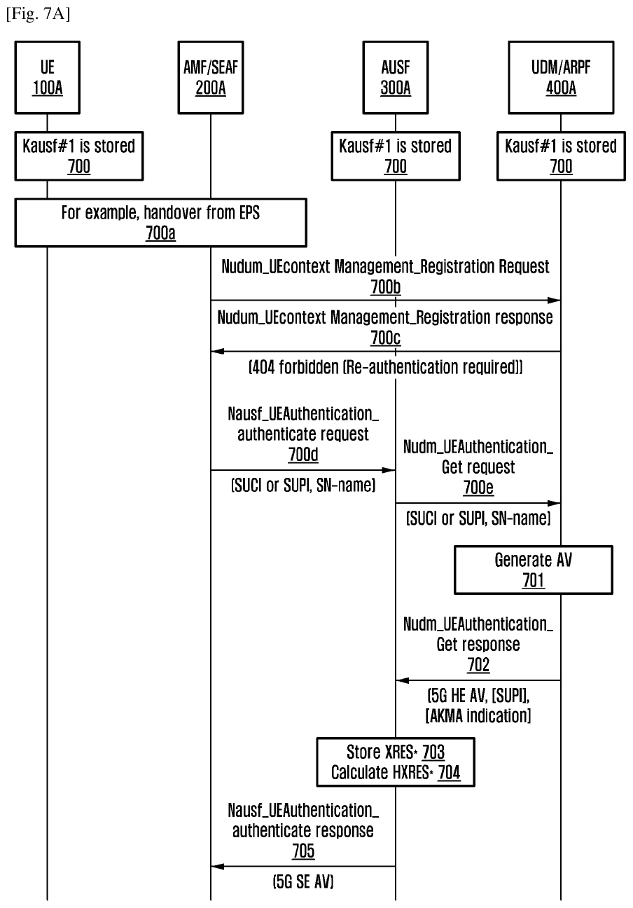

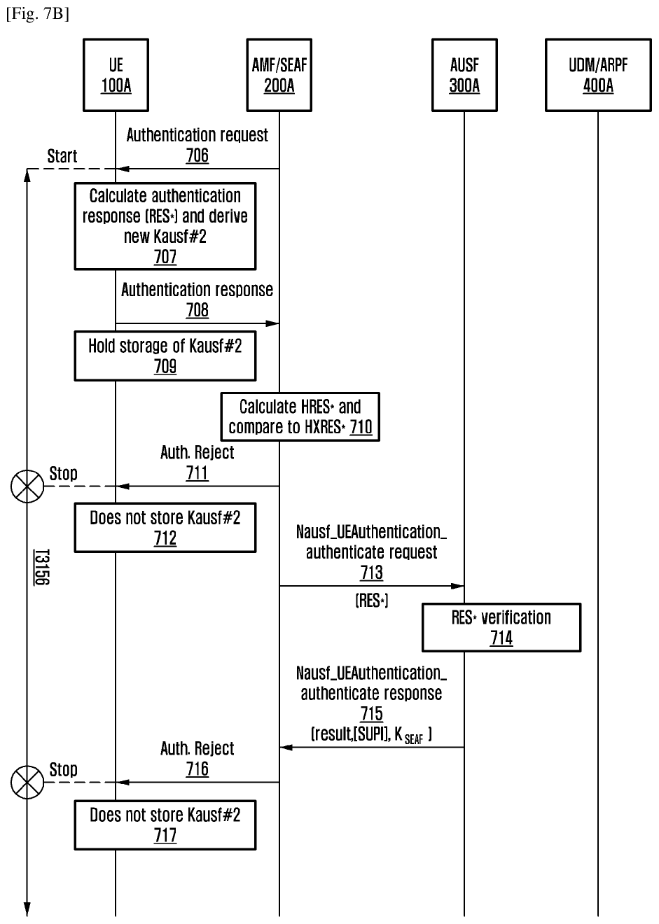

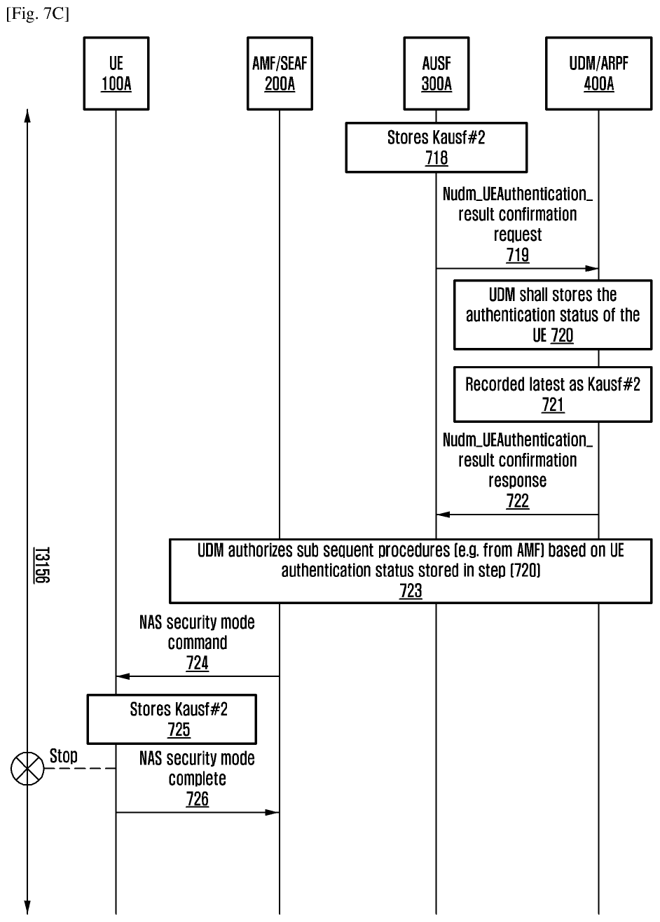

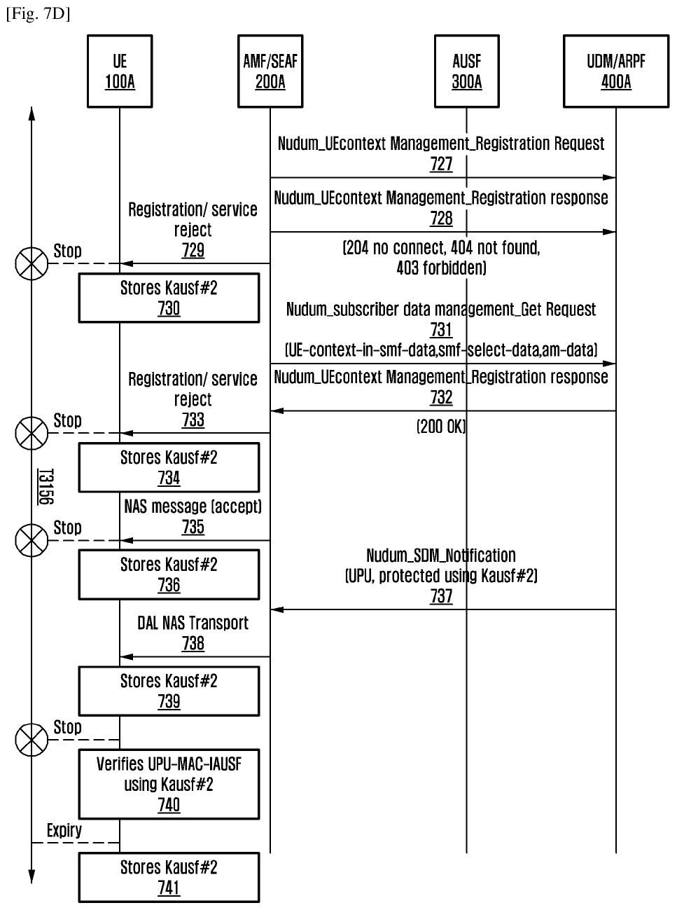

Referring now to the drawings and more particularly to FIGS. 7A through 11, where similar reference characters denote corresponding features consistently throughout the figures, there are shown preferred embodiments.

FIG. 7A to FIG. 7D are sequence diagrams illustrating a proposed method for handling the security key(s) in the wireless network, according to the embodiments as disclosed herein.

At steps 700-700a, a precondition of this illustrative message sequence is that the K_{AUSF} (i.e. KAUSF #1) is established between the UE (100A) and the home network (the AUSF (300A) and the UDM (400A)) resulting from a primary (re)authentication procedure. The UE (100A) is moving from the EPS to the 5GS, due to handover, so as part of the handover procedure, the AMF (200A) requests the UDM (400A) for the UE context management registration.

At step 700b, the AMF/SEAF (200A) sends the Nudm_UEContextManagement_Registration request message to the UDM/ARPF (40). At step 700c, the UDM (400A) sends the Nudm_UEContextManagement_Registration response message indication with 404 forbidden error (re-authentication procedure required), when the UDM (400A) decides the need for (re)authentication. At step 700d, the AMF (200A) sends the Nausf_UEAuthentication_Authenticate Request message to initiate the re-authentication procedure. The AMF (200A) includes the SUPI and the serving network name in the Nausf_UEAuthentication_Authenticate Request message in case the SEAF has a valid 5G-GUTI and re-authenticates the UE (100A). At step 700e, the AUSF (300A) sends the Nudm_UEAuthentication_Get Request to the UDM (400A). The Nudm_UEAuthentication_Get Request includes the SUCI or the SUPI and the serving network name. The AMF (200A) may start illustrative sequence from step 700d, for performing periodic authentication procedures or to refresh/rekeying key hierarchy (from mapped security context to native security context), like so. Based on the SUPI, the UDM (400A) selects the authentication method.

At step 701, the UDM (400A) generates the 5G-HEAV for each authentication get request (Nudm_Authenticate_Get Request). The UDM (400A) generates the AV with the AMF separation bit set to “1”. The UDM (400A) then derives the K_{AUSF} and calculates the XRES*. The UDM (400A) then generates the 5G-HEAV from the RAND, the AUTN, the XRES*, and the K_{AUSF}.

At step 702, the UDM (400A) sends the 5G-HEAV to the AUSF (300A) with an indication that the 5G-HEAV is to be used for the 5G-AKA in the Nudm_UEAuthentication_Get Response. In case, the SUCI was included in the Nudm_UEAuthentication_Get Request, the UDM (400A) includes the SUPI in the Nudm_UEAuthentication_Get Response. If the UE (100A) has the AKMA subscription, then the UDM (400A) includes the AKMA indication in the Nudm_UEAuthentication_Get Response.

At step 703, the AUSF (300A) temporarily stores the XRES* with the received SUCI or SUPI. At step 704, the AUSF (300A) then generates the 5G-AV from the 5G-HEAV received from the UDM (400A) by determines the HXRES* from the XRES* and the K_{SEAF} from the K_{AUSF} and the AUSF (300A) replaces the XRES* with the HXRES* and the K_{AUSF} with the K_{SEAF} in the 5G-HEAV. At step 705, the AUSF (300A) then removes the K_{SEAF} sends the 5G-SEAV (i.e. RAND, AUTN, HXRES*) to the SEAF (200A) in the Nausf_UEAuthentication_Authenticate Response.

At step 706, the SEAF (200A) (or AMF) sends the RAND, the AUTN to the UE (100A) in the NAS authentication request message. The NAS authentication request message includes the ngKSI which is used by the UE (100A) and the AMF (200A) to identify the K_{AMF} and the partial native security context that is created if the authentication is successful. The UE (100A) forwards the RAND and AUTN received in the NAS authentication request message to the USIM of the UE (100A).

At step 707, the USIM of the UE (100A) verifies the freshness of the 5G-AV by checking whether the AUTN can be accepted on receiving the RAND and the AUTN from the AMF (200A). If the AUTN is accepted, then the USIM of the UE (100A) computes the RES. Then the USIM of the UE (100A) returns the RES, the plurality of integrity keys (IK, CK) to the UE (100A). The UE (100A) then determines the RES* from the RES. The UE (100A) calculates the new K_{AUSF} (e.g. K_{AUSF #2}) from the CK∥IK. The UE (100A) then calculates the K_{SEAF} from the K_{AUSF}. The UE (100A) accessing 5G checks during authentication that the “separation bit” in the AMF field of the AUTN is set to 1. The “separation bit” is bit 0 of the AMF field of the AUTN. The UE (100A) starts a timer (e.g. T3516) on the reception of the NAS authentication request message.

At step 708, the UE (100A) sends the RES* to the SEAF (200A) in the NAS authentication response message. At step 709, the UE (100A) holds storage of the new K_{AUSF #2} i.e., the UE (100A) does not overwrite the old K_{AUSF #1}. At step 710, the SEAF (200A) then determines the HRES* from the RES* and the SEAF (200A) compares the HRES* and the HXRES*. If the HRES* and the HXRES* are identical, the SEAF (200A) considers the authentication successful from the serving network point of view. If the Authentication request does not reached the UE (100A), and the RES* is never received by the SEAF (200A), the SEAF (200A) considers authentication as failed, and indicates a failure to the AUSF (300A).

In an embodiment, at steps 711-712, the AMF (200A) sends an authentication reject message to the UE (100A) when the HRES* and the HXRES* are not the same or do not coincide. On receiving the authentication reject message, the UE (100A) stops the timer and the UE (100A) does not store the K_{AUSF #2}. Therefore, the latest key being the K_{AUSF #1} and the UE (100A) indicates abort procedure as specified in TS 24.501, and following further steps are not performed.

At step 713, the SEAF (200A) sends the RES*, as received from the UE (100A) in the Nausf_UEAuthentication_Authenticate Request message to the AUSF (300A). Step 713 is performed, if the SEAF (200A) considers the authentication is successful from the serving network point of view. At step 714, when the AUSF (300A) receives authentication confirmation in the Nausf_UEAuthentication_Authenticate Request message including the RES*, the AUSF (300A) may verify whether the AV has expired. If the AV has expired, the AUSF (300A) may consider the authentication as unsuccessful from the home network point of view. Upon successful authentication, the AUSF (300A) stores the K_{AUSF}. The AUSF (300A) compares the received RES* with the stored XRES*. If the RES* and XRES* are equal, then the AUSF (300A) considers the authentication as successful from the home network point of view.

At step 715, the AUSF (300A) sends indicates the Nausf_UEAuthentication_Authenticate Response to the SEAF (200A), the Nausf_UEAuthentication_Authenticate Response indicates whether the authentication was successful or not, from the home network point of view. If the authentication was successful, then the K_{SEAF} is sent to the SEAF (200A) in the Nausf_UEAuthentication_Authenticate Response.

In an embodiment, at steps 716-717, the AMF (200A) sends the authentication reject message, on receiving the result that authentication was unsuccessful. On receiving the authentication reject message, the UE (100A) does not store the K_{AUSF #2} (which means the latest key being the K_{AUSF #1}), the UE (100A) stops the timer and the UE (100A) indicates abort procedure, as specified in TS 24.501 and following further steps, are not performed.

At step 718, the AUSF (300A) stores the new K_{AUSF} (K_{AUSF #2}) when the authentication was successful. The AUSF (300A) may be overwriting the old one K_{AUSF #1} if the AMF (300A) selects the same instance for the previous authentication also. At step 719, the AUSF (300A) sends the Nudm_UEAuthentication_ResultConfirmation Request to the UDM (400A), the Nudm_UEAuthentication_ResultConfirmation Request includes the result, time of an authentication procedure with the UE (100A), the SUPI, the timestamp of the authentication, the authentication type (e.g. EAP method or 5G-AKA), and the serving network name.

At step 720, the UDM (400A) stores the authentication status of the UE (100A) (e.g. the SUPI, the authentication result, the timestamp, and the serving network name). At step 721, on receiving the authentication status the UDM (400A) considers or records the details of the UE's (100A) authentication events, which have details of the AUSF (300A), which has the latest key K_{AUSF #2} (maybe using timestamp). At step 722, the UDM (400A) sends the Nudm_UEAuthentication_ResultConfirmation Response to the AUSF (300A).

At step 723, the UDM (400A) proceeds with subsequent procedures authorizes based on the stored authentication status in step 720. In an embodiment, at step 724, the AMF (200A) sends a NAS security mode command message to the UE (100A), if the Nausf_UEAuthentication_Authenticate Response (step 715) indicates authentication was successful from the home network point of view. At step 725, the UE (100A) stores the K_{AUSF #2} on receiving the NAS security mode command message and stops the timer. At step 726, the UE (100A) sends a NAS security mode command complete message to the AMF (200A).

At steps 727-728, when the UE's (100A) serving AMF/SEAF (200A) registers itself on the UDM (400A) by sending the Nudm_UEContextManagement_Registration request message. The UDM (400A) responds with the Nudm_UEContextManagement_Registration response message indicating one of “204 no content status”, “403 not found”, “403 forbidden”.

In an embodiment, at step 729, the AMF (200A) sends the registration or service reject message, if the AMF (200A) received the Nudm_UEContextManagement_Registration response message indicating one of “403 not found” and “403 forbidden”. At step 730, even though the UE (100A) received the registration/service reject message, the UE (100A) stores the K_{AUSF #2}, as the UE (100A) considers the authentication is successful. The UE (100A) then stops the timer.

At step 731, the AMF (200A) sends a Nudm_SubscriberDataManagement_Get Request, the Nudm_SubscriberDataManagement_Get Request includes one of UEcontext-in-SMF-data, SMF-select-data, and AM-data. At step 732, the UDM (400A) sends a Nudm_SubscriberDataManagement_Get Response with success status.

In an embodiment, at step 733, the AMF (200A) sends the registration or service reject message, as the AMF (200A) when performing the authorization verifies, identifies the UE (100A) is not authorized for one or more scenarios/criteria/service (for example, tracking area not allowed, serving network not authorized, like so). At step 734, the UE (100A) stores the K_{AUSF #2}, as the UE (100A) considers the authentication is successful. The UE (100A) stops the timer, on receiving the registration or service reject message.

In an embodiment, at step 735, the AMF (200A) sends registration or service accept in a NAS message. At step 736, the UE (100A) stores the K_{AUSF #2}. The UE (100A) stops the timer, on receiving the registration or service accept message. At step 737, the UDM (400A) notifies the AUSF (300A) of updates of subscription data indicated by the “subscription data type” input additional UDM-related parameters and UPU-MAC-I_{AUSF} protected using the K_{AUSF #2} (new AUSF key) in the Nudm_SDM_Notification.

In an embodiment, at step 738, the AMF (200A) sends the DL NAS Transport message to the served UE (100A) upon receiving the Nudm_SDM_Notification message. The AMF (200A) includes in the DL NAS transport message the transparent container received from the UDM (400A). At step 739, the UE (100A) stores the K_{AUSF #2}. The UE (100A) stops the timer, on receiving the DL NAS transport message

In an embodiment, at step 740, the UE (100A) calculates the UPU-MAC-I_{AUSF} using the K_{AUSF #2} and verifies whether it matches the UPU-MAC-I_{AUSF} value received in the DL NAS transport message. If successful/matches the UPU-MAC-I_{AUSF} value, proceed with further procedure. In an embodiment, at step 741, the timer T3156 expires and the UE (100A) stores the K_{AUSF #2}.

The various actions, acts, blocks, steps, or the like in the sequence diagram of the FIG. 7A to FIG. 7D may be performed in the order presented, in a different order or simultaneously. Further, in some embodiments, some of the actions, acts, blocks, steps, or the like may be omitted, added, modified, skipped, or the like without departing from the scope of the invention.

In an example embodiment, the above order of the message sequence in FIG. 7A to FIG. 7D as illustrated (Step 711/716, 724, 729/733, 735, 738) need not to be in sequence. For example, step 738 can occur before step 724.

In an example embodiment, once the UE (100A) stores the K_{AUSF #2}, no further check for the timer and the message (e.g. receiving the NAS security mode command message from the network (200A/300A/400A), receiving the registration accept message from the network (200A/300A/400A), receiving the service accept message from the network (200A/300A/400A), on expiry of the timer T3516, when the UE (100A) enters in a 5GMM-IDLE mode, authentication result with the EAP message IE carrying the EAP-success message) to update the K_{AUSF #2} is performed. In case if the UE (100A) derived new key K_{AUSF #3} (e.g. Once Kausf #2 is stored in the UE (100A), even if a new key Kausf #3 is derived it need not be overwritten).

In an example embodiment, the UE (100A) may not store the K_{AUSF #2} on receiving the NAS messages which does not carry/include UDM transparent container and also not related to the authentication procedure, like, configuration update command.

In an example embodiment, the UE (100A) starts a new timer (for example, T_{xyza} (instead of the T3516)) exclusive for the newly derived K_{AUSF}. The cause of start of the timer at the UE (100A) is transmission of authentication response message to the network (200A/300A/400A). The newly derived K_{AUSF} is deleted and the timer if running, shall be stopped, upon receipt of the authentication result with an EAP message IE carrying the EAP-failure message or the authentication reject message. On expiry of the timer the primary authentication is considered as successful and the newly generated K_{AUSF} is considered as latest K_{AUSF}.

In an example embodiment, the UE (100A) starts a new timer (for example, T_{xyza}) exclusive for indication of failure of the primary authentication. The cause of start of the timer at the AMF (200A) is transmission of the Nausf_UEAuthentication_Authenticate Request (RES*) message to the AUSF (300A). The timer (T_{xyza}) shall be stopped, if there is response for the transmitted request message. On expiry of the timer (T_{xyza}), the primary authentication is considered as unsuccessful and the AMF (200A) sends the authentication reject message.

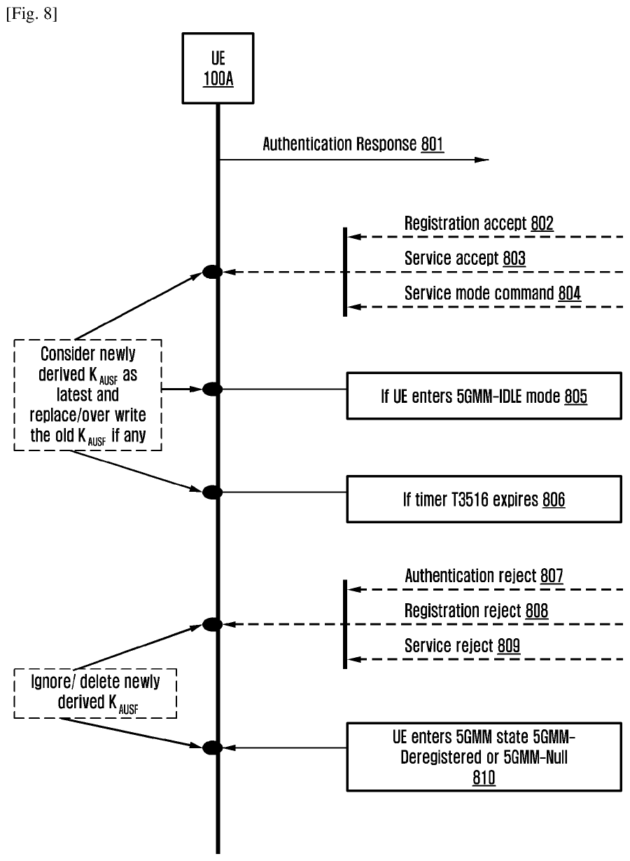

FIG. 8 is a signaling diagram illustrating a scenario for handling the security key(s) based on the timer and reception of a message(s) from the wireless network, according to the embodiments as disclosed herein.

At step 801, the UE (100A) sends the authentication response message to the network on receiving the authentication request message from the network, same as explained in previous FIGS. In an example embodiment, when the timer T3516 is running at the UE (100A) and if following event happens, then authentication is to be considered as successful and newly derived K_{AUSF} to be considered as latest K_{AUSF} and the existing K_{AUSF} will be overwritten or replaced by the newly derived K_{AUSF}. Examples of the following event such as receiving the NAS security mode command message (804) from the network, receiving the registration accept message (802) from the network, receiving the service accept message (803) from the network, on expiry of timer T3516 (806), when the UE (100A) enters in a 5GMM-IDLE mode (805), authentication result with the EAP message IE carrying the EAP-success message.

In an example embodiment, when the timer T3516 is running at the UE (100A) and if following event happens, then authentication is to be considered as unsuccessful and newly derived K_{AUSF} will not be considered as latest K_{AUSF} or the existing K_{AUSF} will not be overwritten or not replaced by the newly derived K_{AUSF}. Examples of the following event such as receiving the service reject message (809) from the network, receiving the registration reject message (808) from the network, receiving the authentication reject message (807) from the network, when the UE (100A) enters in a 5GMM state 5GMM-DEREGISTERED or 5GMM-NULL (810), and authentication result with the EAP message IE carrying the EAP-failure message.

In an example embodiment, if the timer (T3516) is running, the UE (100A) waits for the timer (T3516) to expire and does not use the newly derived K_{AUSF} for verifying the control plane messages. If the timer (T3516) is not running, partial context is stored or taken in to use, the UE (100A) consider newly derived K_{AUSF} as latest and Replace/Over-write the old K_{AUSF} if any. If the timer (T3516) is not running, partial context is deleted, then the UE (100A) ignore the newly derived K_{AUSF} and shall not replace/over-write the old K_{AUSF} if any.

In an example embodiment, after a primary authentication, when a new partial native 5G NAS security context is created and/or the newly created partial native 5G NAS security context is taken into use through a security mode control procedure, then the newly generated K_{AUSF} is considered as the latest K_{AUSF}. Otherwise, the newly created K_{AUSF} is deleted/ignored/not taken as latest K_{AUSF}.

In an example embodiment, primary authentication is considered as successful, if partial native security context is created. The UE (100A) stores the latest K_{AUSF} after successful completion of the latest primary authentication.

In an example embodiment, if the timer (T3516) is running and the authentication reject is received, then K_{AUSF} is not taken as the latest K_{AUSF}. Otherwise, it is considered to be authentication successful and K_{AUSF} is also stored in the network.

In an example embodiment, only if the timer (T3516) is stopped by the authentication reject message, then K_{AUSF} is not taken as latest K_{AUSF}. If the timer (T3516) is stopped by any other message, then primary authentication is considered to be successful.

In an example embodiment, when the primary authentication is ongoing, the UE (100A) will hold the initiation of the AKMA related procedures, till the primary authentication completes. Once the primary authentication primary authentication is completed, then the UE (100A) use the latest K_{AUSF} for the AKMA procedures. Since AKMA keys are based on K_{AUSF} from primary authentication run, the AKMA keys can only be refreshed by running a fresh primary authentication. A partial native 5G NAS security context is established in the UE (100A) and the network when a 5G authentication is successfully performed and SMC procedure is not mandatory after the authentication request response. The partial security context will be existing and the latest K_{AUSF} is created. In AKMA procedure, when re-authentication runs, the AUSF (300A) generates a new A-KID (AKMA), and a new K_{AKMA} (AKMA key) and sends the new generated A-KID and K_{AKMA} to the AAnF (AKMA Anchor Function). After receiving the new generated A-KID and K_{AKMA}, the AAnF deletes the old A-KID and K_{AKMA} and stores the new generated A-KID and K_{AKMA}.

In an example embodiment, when the primary authentication is ongoing for the UE (100A), the AMF (200A) will drop the request/messages related to Nudm_SDM_Notification service operation, till the primary authentication completes.

In an example embodiment, K_{AUSF} handling during emergency sessions, when the UE (100A) initiates a registration procedure with 5GS registration type IE set to “emergency registration” and the NAS SMC procedure signals use of NIA0 and NEA0, then the UE (100A) considers the Authentication procedure as failed and the newly derived K_{AUSF} will not be considered as latest K_{AUSF} or existing K_{AUSF} will not be rewritten or replaced by this newly derived K_{AUSF}.

In an example embodiment, explicit indication of authentication status, the network (AMF (200A)) explicitly indicates the result of the primary authentication to the UE (100A) in the NAS message for the primary 5G-AKA authentication method. The AMF (200A) sends authentication result to convey authentication is successful, if the result indication in the Nausf_UEAuthentication_Authenticate Response received from the AUSF (300A) by the AMF (200A) is indicated as successful.

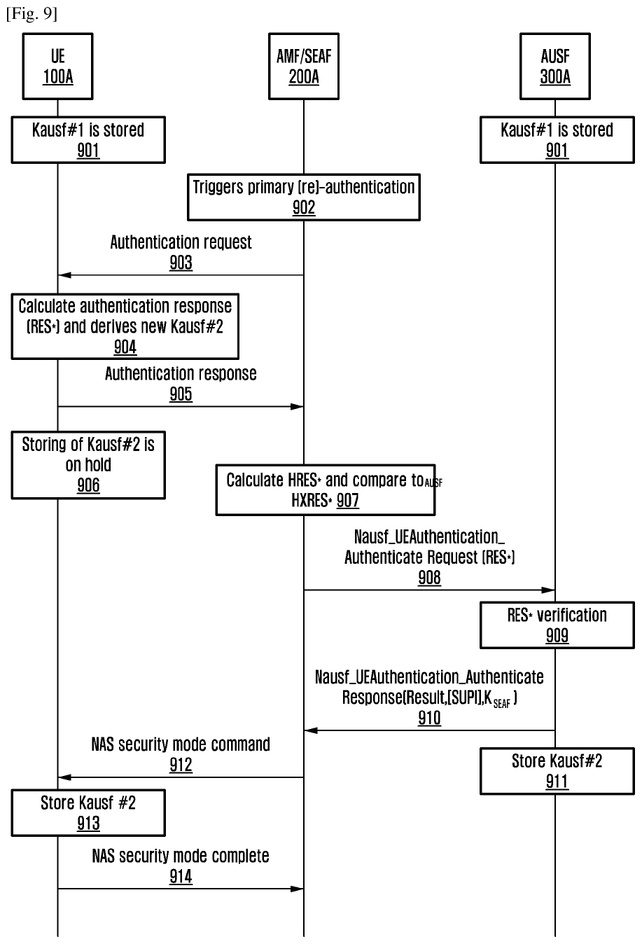

FIG. 9 illustrates a signaling diagram as a combined embodiments as disclosed herein;

At step 901, a precondition of this illustrative message sequence is that the K_{AUSF} (i.e. K_{AUSF #1}) is established between the UE (100A) and the home network (the AUSF (300A) (not shown in FIG.)). At step 902, the AMF (200A) (or SEAF) triggers re-authentication and decides to send authentication request message to the UE (100A). At step 903, the SEAF (200A) (or AMF) sends the NAS authentication request message. At step 904, the UE (100A) calculates the new K_{AUSF} (e.g. K_{AUSF #2}) from the keys CK & IK, if the verification of the AUthentication TokeN (AUTN) is successful. The UE (100A) then calculates the K_{SEAF} from the K_{AUSF}.

At step 905, the UE (100A) sends the authentication response message to the AMF (200A). At step 906, the UE (100A) holds storage of the new K_{AUSF #2} i.e., the UE (100A) does not overwrite the old K_{AUSF #1}. At step 907, the AMF and/or SEAF (200A) verifies the authenticity from the serving network point of view. At step 908, the SEAF (200A) sends the Nausf_UEAuthentication_Authenticate Request message to the AUSF (300A). At step 909, the AUSF (300A) verifies the authenticity of the UE (100A) and then the AUSF (300A) considers the authentication as successful from the home network point of view if the verification is successful.

At step 910, the AUSF (300A) sends the Nausf_UEAuthentication_Authenticate Response to the SEAF (200A) indicating whether the authentication was successful or not, from the home network point of view. If the authentication was successful, then the K_{SEAF} is sent to the SEAF (200A) in the Nausf_UEAuthentication_Authenticate Response. At step 911, upon successful verification, the AUSF (300A) stores the K_{AUSF} (K_{AUSF #2}).

In an embodiment, at step 912, the AMF (200A) sends a NAS security mode command message to the UE (100A)), to bring into use the partial native 5G NAS security context created by the primary (re)authentication and key agreement procedure. At step 913, the UE (100A) stores the K_{AUSF #2} on receiving the valid NAS security mode command message and stops the timer. At step 914, the UE (100A) sends the NAS security mode command complete message to the AMF (200A), in response to the valid NAS security mode command message.

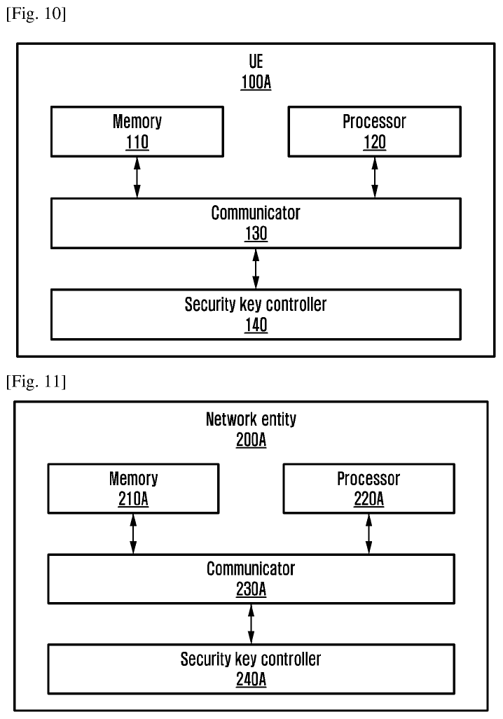

FIG. 10 illustrates a block diagram of the UE (100A) for handling the security key(s) in the wireless network, according to the embodiments as disclosed herein. The UE (100A) can be, for example, but are not limited, to a smartphone, a robotic device, and an Internet of things (IoT) device.

In an embodiment, the UE (100A) includes a memory (110), a processor (120), a communicator (130), and a security key controller (140).

In an embodiment, the memory (110) is configured to store an old security key (e.g. K_{AUSF-1}), and a new security key (e.g. K_{AUSF-2}). The memory (110) stores instructions to be executed by the processor (120). The memory (110) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (110) may, in some examples, be considered a non-transitory storage medium. The term “non-transitory” may indicate that the storage medium is not embodied in a carrier wave or a propagated signal. However, the term “non-transitory” should not be interpreted that the memory (110) is non-movable. In some examples, the memory (110) can be configured to store larger amounts of information than the memory. In certain examples, a non-transitory storage medium may store data that can, over time, change (e.g., in Random Access Memory (RAM) or cache). The memory (110) can be an internal storage unit or it can be an external storage unit of the UE (100A), a cloud storage, or any other type of external storage.

The processor (120) communicates with the memory (110), the communicator (130), and the security key controller (140). The processor (120) is configured to execute instructions stored in the memory (110) and to perform various processes. The processor (120) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (130) is configured for communicating internally between internal hardware components and with external devices (e.g. AMF/SEAF (200A), AUSF (300A), and UDM (400A))) via one or more networks (e.g. Radio technology). The communicator (130) includes an electronic circuit specific to a standard that enables wired or wireless communication.

The security key controller (140) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the security key controller (140) receives the NAS authentication request message from the network entity (200A) (i.e. AMF/SEAF), where the UE (100A) holds the first HN security key (e.g. K_{AUSF-1}) Further, the security key controller (140) determines the authentication response message for the received NAS authentication request message and generating the second HN security key (e.g. K_{AUSF-2}) from the plurality of input parameters (e.g. integrity keys (IK, CK)) received in the NAS authentication request message. Further, the security key controller (140) sends the authentication response message to the network entity (200A). Further, the security key controller (140) performs one of: storing the second HN security key in response to receiving a NAS security mode command message from the network entity (200A) or ignore the second HN security key in response to receiving a NAS reject message from the network entity (200A).

The UE (100A) holds the second HN security key and stores the second HN security key only after receiving the NAS security mode command message; wherein the first HN security key is overwritten by the second HN security key. The network entity (200A) sends the NAS authentication request message to the UE (100A) for re-authenticating the UE (100A). The first HN security key and the second HN security key are key K_{AUSF}, established between the UE (100A) and the HN resulting from the primary (re)authentication procedure.

Further, the security key controller (140) determines when a new partial native 5G NAS security context is created and/or the newly created partial native 5G NAS security context is taken into use through a security mode control procedure. Further, the security key controller (140) overwrites the first HN security key with the second HN security key in response to determining that the new partial native 5G NAS security context is created and/or the newly created partial native 5G NAS security context is taken into use through the security mode control procedure. Further, the security key controller (140) not overwrites the first HN security key with the second HN security key in response to determining that the new partial native 5G NAS security context is not created and/or the newly created partial native 5G NAS security context is not taken into use through the security mode control procedure.

Further, the security key controller (140) initiates a registration procedure with 5GS registration type IE set to an emergency registration. Further, the security key controller (140) determines whether NAS Security mode procedure signals use of NIA0 and NEA0. Further, the security key controller (140) ignores the second HN security key in response to determining that the NAS SMC procedure signals use of NIA0 and NEA0.

Although the FIG. 10 shows various hardware components of the UE (100A) but it is to be understood that other embodiments are not limited thereon. In other embodiments, the UE (100A) may include less or more number of components. Further, the labels or names of the components are used only for illustrative purpose and does not limit the scope of the invention. One or more components can be combined together to perform same or substantially similar function to handle synchronization of the HN security key(s) in the wireless network.

FIG. 11 illustrates a block diagram of the network entity (200A) for handling the security key(s) in the wireless network, according to the embodiments as disclosed herein.

In an embodiment, the network entity (200A) includes a memory (210A), a processor (220A), a communicator (230A), and a security key controller (240A).

In an embodiment, the memory (210A) is configured to store an old security key (e.g. K_{AUSF-1}), and a new security key (e.g. K_{AUSF-2}). The memory (210A) stores instructions to be executed by the processor (220A). The memory (210A) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (210A) may, in some examples, be considered a non-transitory storage medium. The term “non-transitory” may indicate that the storage medium is not embodied in a carrier wave or a propagated signal. However, the term “non-transitory” should not be interpreted that the memory (210A) is non-movable. In some examples, the memory (210A) can be configured to store larger amounts of information than the memory. In certain examples, a non-transitory storage medium may store data that can, over time, change (e.g., in Random Access Memory (RAM) or cache). The memory (210A) can be an internal storage unit or it can be an external storage unit of the network entity (200A), a cloud storage, or any other type of external storage.

The processor (220A) communicates with the memory (210A), the communicator (230A), and the security key controller (240A). The processor (220A) is configured to execute instructions stored in the memory (210A) and to perform various processes. The processor (220A) may include one or a plurality of processors, maybe a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

The communicator (230A) is configured for communicating internally between internal hardware components and with external devices (e.g. UE (100A), AUSF (300A), and UDM (400A))) via one or more networks (e.g. Radio technology). The communicator (230A) includes an electronic circuit specific to a standard that enables wired or wireless communication.

The security key controller (240A) is implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports such as printed circuit boards and the like.

In an embodiment, the security key controller (240A) determines authenticity of the UE (100A) from a serving network point of view when the network entity (200A) receives a NAS authentication response message from the UE (100A). Further, the security key controller (240A) determines authenticity of the UE (100A) from a home network point of view when the network entity (200A) receives a Nausf_UEAuthentication_Authenticate Response from an Authentication Server Function (AUSF) entity (300A). Further, the security key controller (240A) sends a NAS Security Mode Command (SMC) message to the UE (100A), if the network entity (200A) determines that the authenticity of the UE (100A) is verified successfully from both serving network point of view and home network point of view.

Although the FIG. 11 shows various hardware components of the network entity (200A) but it is to be understood that other embodiments are not limited thereon. In other embodiments, the network entity (200A) may include less or more number of components. Further, the labels or names of the components are used only for illustrative purpose and does not limit the scope of the invention. One or more components can be combined together to perform same or substantially similar function to handle synchronization of the HN security key(s) in the wireless network

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1.-15. (canceled)

16. A method performed by a user equipment (UE) in a wireless network, the method comprising:
receiving, from a network entity, a non-access stratum (NAS) security mode command message after an authentication, in case that the authentication is successful from a home network (HN) point of view;
identifying that the authentication is successful based on the NAS security mode command message; and
storing a first security key that is newly generated as a latest key.

17. The method of claim 16, further comprising:
receiving a NAS authentication request message associated with the authentication; and
transmitting a NAS authentication response message.

18. The method of claim 16, wherein the storing of the first security key includes storing the first security key as the latest key by replacing or overwriting a second security key by the first security key.

19. The method of claim 18, wherein the second security key is a key K_{AUSF}, established between the UE and the HN resulting from a primary authentication procedure performed before a latest primary authentication procedure.

20. The method of claim 16, further comprising:
transmitting, to the network entity, a NAS security mode complete message.

21. The method of claim 16, wherein the NAS security mode command message is received to take a newly created partial native fifth generation (5G) NAS security context into use.

22. The method of claim 16, further comprising:
determining whether a NAS security mode procedure associated with an emergency registration signals use of NIA0 and NEA0,
wherein the first security key is not stored, in case that the NAS security mode procedure signals use of NIA0 and NEA0.

23. A user equipment (UE) in a wireless network, the UE comprising:
a memory;
a processor; and
a security key controller, operably connected to the memory and the processor, configured to:
receive, from a network entity, a non-access stratum (NAS) security mode command message after an authentication, in case that the authentication is successful from a home network (HN) point of view,
identify that the authentication is successful based on the NAS security mode command message, and
store a first security key that is newly generated as a latest key.

24. The UE of claim 23, wherein the processor is further configured to:
receive a NAS authentication request message associated with the authentication, and
transmit a NAS authentication response message.

25. The UE of claim 23, wherein the NAS security mode command message is received to take a newly created partial native fifth generation (5G) NAS security context into use.

26. A network entity in a wireless network, the network entity comprising:
a memory;
a processor; and
a security key controller, operably connected to the memory and the processor, configured to:
identify that an authentication is successful from a home network (HN) point of view, and
transmit, to a user equipment (UE), a non-access stratum (NAS) security mode command message after the authentication, in case that the authentication is successful from the HN point of view,
wherein a first security key that is newly generated is stored as a latest key.

27. The network entity of claim 26, wherein the authentication from the HN point of view is determined as being successful based on a Nausf_UEAuthentication_Authenticate Response.

28. The network entity of claim 26, wherein the NAS security mode command message is transmitted to take a newly created partial native fifth generation (5G) NAS security context into use.

29. A method performed by a network entity in a wireless network, the method comprising:
identifying that an authentication is successful from a home network (HN) point of view; and
transmitting, to a user equipment (UE), a non-access stratum (NAS) security mode command message after the authentication, in case that the authentication is successful from the HN point of view,
wherein a first security key that is newly generated is stored as a latest key.

30. The method of claim 29, further comprising:
transmitting, to the UE, a NAS authentication request message associated with the authentication; and
receiving, from the UE, a NAS authentication response message.
